(19) United States
(12) Patent Application Publication
(10) Pub. No.: US 2007/0266752 A1
(43) Pub. Date: Nov. 22, 2007

(54) System for Metering the Bending Angle in a Machine for Bending Metallic Sheets and/or Sections, as Well as Method and Machine for Bending Metallic Sheets and/or Sections Using Such System

(75) Inventors: Luigi Patuzzi, Monteforte d'Alpone (IT); Carlo Ganassini, Isola della Scala (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: FINN-POWER OY, KAUHAVA FINLAND (FI)

(21) Appl. No.: 10/559,068

(22) PCT Filed: Jun. 4, 2003
(86) PCT No.: PCT/IT03/00348

§ 371 Date: Mar. 12, 2007

(51) Int. Cl. B21C 51/00; B23Q 17/22

(52) U.S. Cl. 72/16.1; 33/710

(57) ABSTRACT

A system is described for metering the bending angle of a metal sheet or section (35) in a bending machine (10) which comprises a fixed bed to support the sheet or section (35) to be machined, a support frame (12) for a press (15) comprising at least one mobile punch (32) and a corresponding fixed counter-punch (24) acting as temporary clamping means of the sheet or section (35) during the bending stage, also comprising at least one bending blade (20, 21) which in operation can be moved towards and away from the sheet or section (35) being machined, in order to shape this sheet or section (35). This system also comprises means for the remote measurement (39) of the instantaneous bending angle (α) of the piece (35) being machined, the measurement means (39) being suitable to take measurements at least two points of the distance of the piece (35) from the measurement means (39), to process the data relative to the distances measured, to obtain a value corresponding to the instantaneous bending angle (α) and to convert this value to an electric signal that can be subsequently used in order to check the implementation of the bending method.

### TECHNICAL FIELD

This invention concerns a system for metering the bending angle for a bending machine for metal sheets and/or sections.

More in particular, this invention refers to a system for metering the material bending angle designed to be used on a bending machine for shaping semi-finished metal parts in general.

Furthermore, the invention refers to a method for the bending of metal sheets and/or sections in which this system for metering the material bending angle is used, and to a bending machine for metal sheets and/or sections using this system.

The main application of this invention is in the mechanical manufacturing industry sector.

### BACKGROUND ART

The bending of semi-finished metal sheets and/or sections, for example in order to obtain metal box-like structures, is generally achieved by means of bending machines which normally consist of:
a fixed support table for a material, for example a metal sheet, to be bent;
a support frame for a clamping press;
at least one punch, which is part of this press, and a corresponding counter-punch designed as clamping means for the material during bending;
one or more bending blades which can be moved towards the material being machined;
appropriate kinematic motions designed to move the bending blade or blades along the bed to shape the piece clamped between the punch and the counter-punch;
means for the transfer of the sheet or section, in order to move it towards the blade in working conditions;
transducers and sensors of various kinds, to control the process being carried out, connected to an electronic control unit designed to manage the production process.

The method for bending the sheet or section consists of:
a preparation stage in which the material is clamped on the fixed bed against appropriate means of transfer;
the transfer of a flap of the sheet towards the bending blade or blades;
the positioning of an edge of the material above the counter-punch and the subsequent descent of the punch, activated by the press, to ensure the clamping of the material close to the bending blade(s), maintaining a flap of the material protruding towards the blade(s);
the approach of at least one blade towards the sheet or section until the protruding flap is compressed to obtain a predetermined shape;
the withdrawal of the blade pressing the material being machined;
the unclamping of the sheet by raising of the punch followed by repositioning of the partially machined material;
the infeed and/or rotation of the material until the position foreseen for the next bend;
reclamping of the sheet by means of the press;
repetition of the machining stages for further bends;
unclamping of the finished product and its subsequent extraction from the bending machine.

The positioning of the bending blades must be extremely precise; in fact any errors, even minimal ones, are amplified as the various subsequent bends are made.

The centering of the press punch is calibrated by subsequent approximations, taking into account the response in terms of elasticity of the batch of material being machined, usually on the basis of the experience of the person operating the machines, for which a period of specialised training is required.

Moreover, a bending machine of the type described above, marketed by the applicant hereto, comprises a blade-holder structure with a “C” shaped cross-section, moving in two directions at right angles to each other with respect to the fixed bed, on which the bending blade(s) is(are) fixed.

In some particular applications, this blade-holder structure also comprises an ASP carriage, which consists of a device which moves in a direction at right-angles to the aforesaid movement directions of the structure.

This ASP carriage generally supports one or two bending blades and is used to bend just one portion of the material protruding from the tools.

One drawback of the bending machines known to the prior art is represented by the fact that bending carried out in a series of stages with repositioning of the material being machined takes rather a long time.

Another drawback is represented by the fact that the automatic preparation of the subsequent bending stages cannot take particular cases into account in which the metal material does not behave in a conventional and foreseeable way with the resulting effect of reject production.

Yet another drawback is represented by the fact that the machining of metallic materials for which no previous experience is available requires tests and attempts with inevitable additional production costs.

### DESCRIPTION OF THE INVENTION

According to a first aspect this invention proposes to provide a system for metering the material bending angle which can be used on a bending machine for shaping metal sheets and/or sections and which can eliminate or significantly reduce the drawbacks described above.

This is achieved by means of a system with the features described in the main claim.

The dependent claims described advantageous embodiments of the invention.

According to another aspect this invention proposes to provide a method for obtaining shaped metal sheets and sections which can ensure high productivity levels with a minimum number of rejects.

This is achieved by means of a method with the features described in claim 4.

The dependent claims described advantageous embodiments of the invention.

Finally, this invention proposes to provide a machine for bending metal sheets and/or sections and designed to implement the above method.

Such a bending machine is described in claim 6 and in the relative dependent claims.

According to an essential feature of the invention, the system according to this invention comprises means for metering the bending angle designed to measure the distance of the material being bent from the metering means, in at least two points, to compare these distances, to instantaneously calculate the bending angle and to issue an electrical signal representing the measurement made.

This signal is then used, according to the application, for various purposes, for example to carry out a manual adjustment of the machine bending parameters, to make an automatic adjustment with negative feedback control of these parameters, or to perform spot checks on the bends made.

Advantageously, the metering means consist of one or more optical laser sensors connected to an electronic control unit in order to immediately provide the data relative to the actual bending angle achieved.

According to other embodiments foreseen by the invention, the metering means can consist of scanning laser sensors, infrared sensors, ultrasound sensors or mechanical sensors.

One particularly interesting embodiment of the invention consists of implementation of the metering system on a mobile ASP carriage enclosed in a “C” shaped blade-holder structure.

In this particular case, the adaptation of the system according to the invention to an existing bending machine is very easy.

In practice, according to a particularly advantageous embodiment of the invention, the control unit modifies the positioning of the material being machined as well as the machining parameters such as, for example, the pressing force that the blade can exert and the alignment of the blades.

In this case, the profile of the bent edge with particular reference to the angle obtained is checked by means of an immediate feedback system guaranteed by the prompt response of the electronic control unit following the data received from the sensor.

If this sensor is positioned on an ASP carriage Which slides parallel to the blade-holder structure, it is possible to check the entire bent flap of the piece being machined, ensuring absolute uniformity of the section.

### DESCRIPTION OF THE DRAWINGS

Other features and advantages of the invention will become evident on reading the following description of one embodiment of the invention, given as a non-binding example, with the help of the enclosed drawings, in which:

FIG. 1 shows an enlarged scale cross-section side view of the bending unit of a machine for bending metal sheets known to the background art;

FIG. 2 is a perspective side view of the bending unit of a machine for bending metal sheets;

FIG. 3.is an elevated side view of a carriage and of blades in working position and shows the method for bending a sheet performed by the bending machine; and

FIG. 4 is an elevated side view of a carriage containing a support block for a metering device designed to implement the system for metering the bending angle according to this invention.

### DESCRIPTION OF ONE EMBODIMENT

In the figures, the reference number 10 indicates in general a bending machine, in the case in question a bending machine 10 for metal materials 35 being machined, a frame 12 supporting a blade-holder structure 13 with a “C” shaped cross-section, a carriage 14 supporting metering sensors and a press 15 for clamping the sheet 35 during bending.

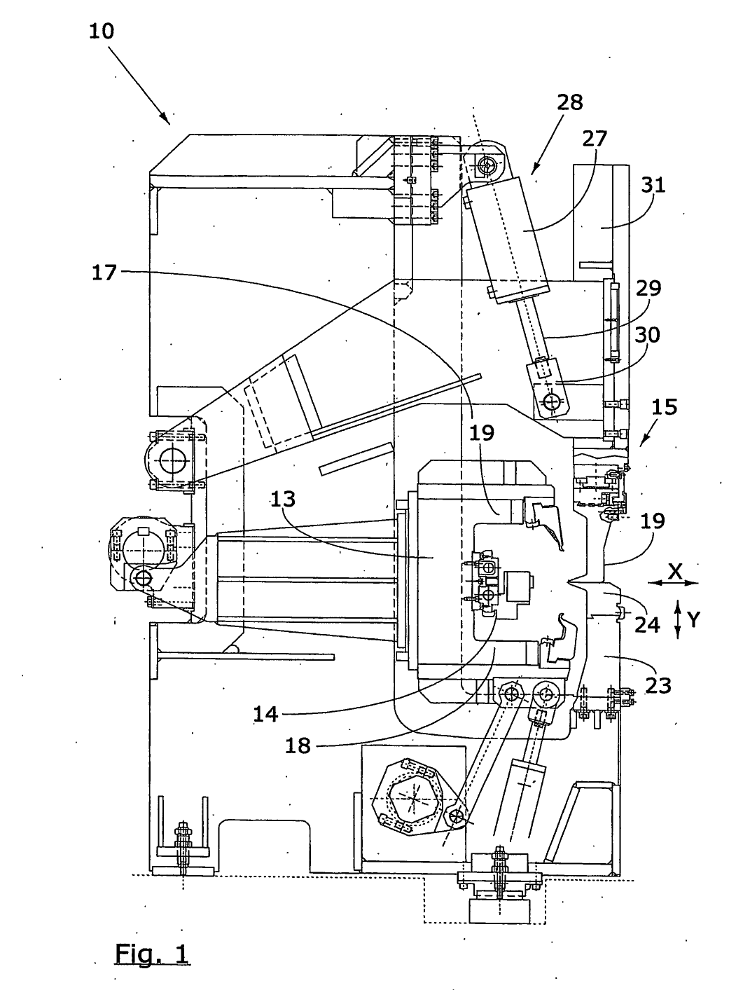

As can be seen in FIG. 1, the structure 13 moves along two mutually perpendicular axes X and Y with respect to the fixed frame 12 of the machine 10.

The structure 13, which in the illustrated embodiment has a “C” shaped cross-section, is equipped with a pair of arms, respectively one lower arm 18 and one upper arm 19, facing the outer part of the frame 12.

The projecting ends of the arms 18, 19 are designed to support respective blades 20, 21, the base of each blade 20, 21 being housed in a respective support 22.

The outer portion of the frame 12, near the gap 17, comprises a plinth 23 designed to support a counterpunch 24 equipped with an upper bed 25 terminating with a lip 26 projecting towards the structure 13.

The portion of the frame 12 above the gap 17 is hinged to a cylinder 27 of a linear actuator 28 whose shaft 29 is equipped with a coupling 30 to the casing 31 of the press 15.

The casing 31 comprises a shaft terminating with a punch 32, above the counterpunch 24, with a flat end 33 and a projection 34 in operation corresponding to the lip 26 of the bed 25 of the counterpunch 24.

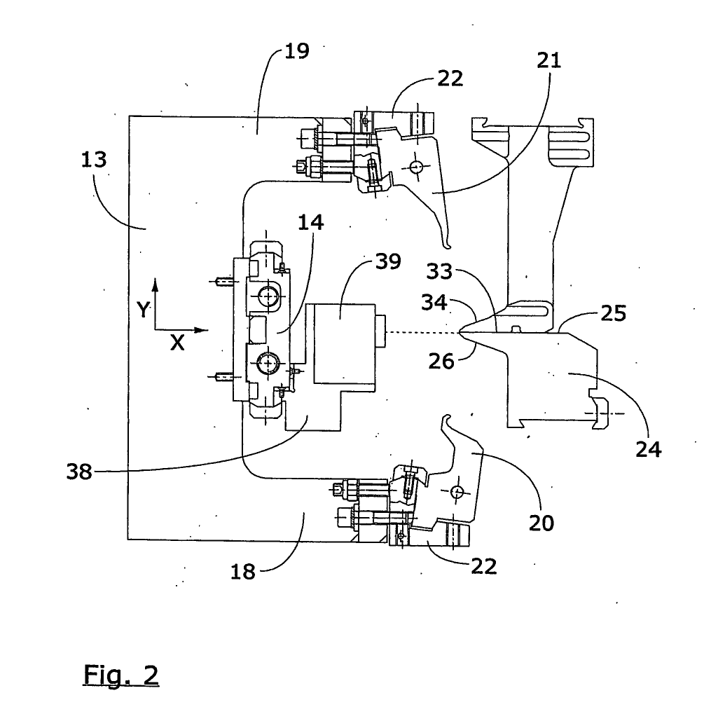

With reference to FIG. 2, it can be seen that the punch 32 and the counterpunch 24 present an extended longitudinal development being designed to temporarily clamp the edge of a piece of sheet during bending.

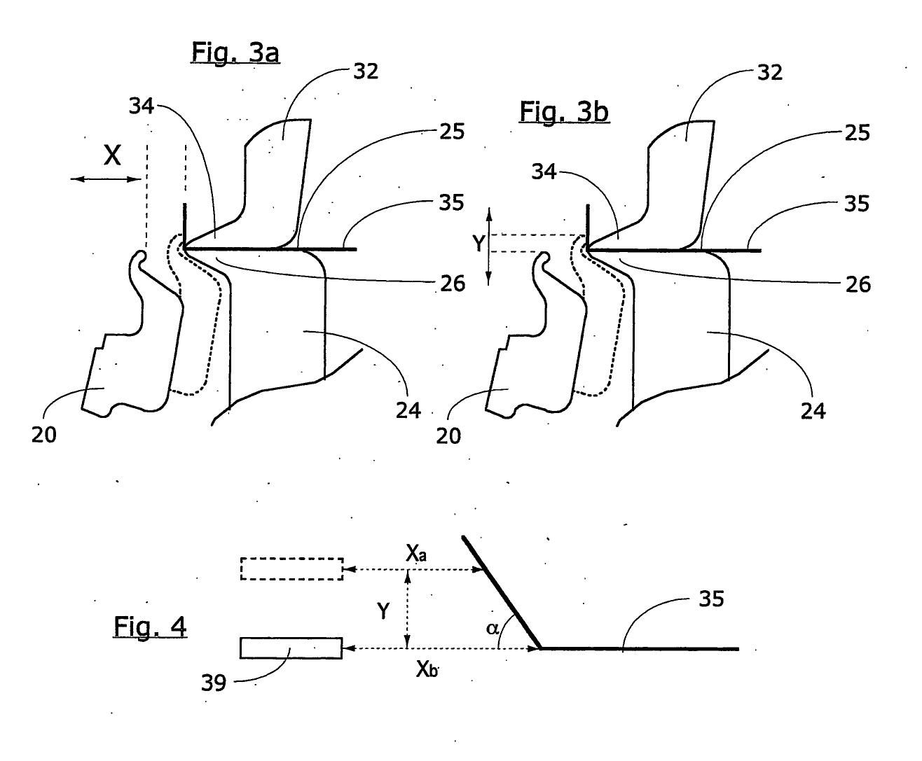

As can be seen in FIG. 3, an edge of a piece to be bent 35 is placed on the bed 25 of the counterpunch 24 and clamped by the descent of the punch 32.

The lower blade 20 of the structure 13 can perform travels corresponding to a predetermined positioning for the bending of the edge of the piece 35.

In particular the protruding end of the blade 20 can be moved in a horizontal direction as indicated by the arrows marked with X, and in a vertical direction as indicated by the arrows marked with Y.

In this way, the flap of material 35 protruding from the lip 26 and the end 34 of the punch 32 is pressed and the edge of the piece 35 is bent.

With reference to FIG. 4, an ASP carriage 14 is housed inside the blade-holder structure 13 sliding on a respective guide 37 which is integral with the structure 13.

The ASP carriage therefore moves at right angles to the plane defined by the X and Y axes.

The ASP carriage 14 is equipped with a bracket 38 extending towards the central part of the structure 13 and designed to support a device 39 for the measurement of the bending angle of the piece 35.

According to a particularly advantageous embodiment, the metering device 39 can be optical, for example a laser sensor with movements controlled by the structure 13 and the carriage 14 according to three axes at right angles to each other.

The machine 10 comprises an electronic control unit (not shown in the drawings) electrically connected to the device 39 and to any other sensors designed to control the bending process.

According to one embodiment, this control unit can also adjust the machining parameters, being connected to kinematic motions which move the structure 13 and the supports 22, as well as the press 15.

The immediate measurement of the bending angle of the piece 35 is transformed into an electric signal corresponding to this bending angle, and this electric signal can be subsequently used in different ways.

For example, in a machine with automatic control of the machining parameters, the measurement signal permits prompt modification of the parameters and the control follows, a feedback principle aimed at considerably reducing inaccuracies due to repeated positioning errors.

By way of a non-binding example, the laser sensor 39 can be the CCD type and the carriage 14 can be an ASP type carriage.

Other types of sensors can, obviously, be used; the carriage 14, on the other hand, is not always necessary: according to other embodiments of the invention, the system is equipped with at least one fixed metering sensor, for example a scanning laser type sensor.

Moreover, as regards the general layout of the bending machine, the sliding axes of the moving parts are numerically controlled and the movements can be carried out by using pneumatic energy.

### DESCRIPTION OF THE METHOD

If the bending machine consists of a machine of the type described above, i.e. comprising a “C” shaped blade-holder structure and an ASP carriage on which an appropriate sensor is positioned, the machining procedure of the piece 35, which generally consists of a sheet metal sheet, foresees:
a preparation stage in which the sheet 35 is placed on the fixed bed for feeding into the bending machine 10;
the transfer of the sheet 35 towards the blade-holder structure 13;
the positioning of an edge of the sheet 35 an d its subsequent clamping adjacent to the structure 13 keeping one flap protruding towards the blades. 20, 21 of the structure 13;
the approach of at least one blade 20, 21 of the structure 13 towards the sheet 35 being machined until the protruding flap is compressed to obtain a predetermined shape;
the withdrawal of the blade 20, 21 from the sheet 35 being machined;
measurement of the bending angle by means of a sensor 39;
manual or automatic checking of the alignment of the blades 20, 21 and of calibration of the machining parameters;
calibration of the centering of the clamping device 15 of the sheet 35 being machined.
unclamping and repositioning of the partially machined sheet;
reclamping of the semi-finished sheet;
repetition of the machining, measurement and checking stages;
unclamping of the finished product and its subsequent extraction from the bending machine 10.

The procedure may foresee spot checks on the dimensions of the finished product 35, carried out with the same device 39 used to measure the bending angle.

According to an advantageous embodiment of the invention, the bending angle is measured positioning the sensor 39 in two separate vertical and lateral positions with respect to the bent edge of the sheet 35.

By means of a laser beam, the sensor measures two horizontal distances defined as Xₐ ed X_{b}. Since the vertical movement, defined as Y, of the sensor 39 is also known, the outer bending angle a can be easily determined as an arc tangent of the ratio between Y and the difference between X_{b} and Xₐ:
α=arctan (Y/X_{b}−Xₐ))

The Xₐ and X_{b} measurements take into account a series of problems due both to vibrations and to electromagnetic noise.

This is the reason why the definition of the bending angle is not based on the measurement of just two positions but on a rapid collection of data relative to numerous measurements.

This temporary archive of data is processed by means of a linear regression procedure taking into account a trend based on the determination of the minimum sum of the standard deviation.

The measurement process according to one embodiment of this invention takes place according to the stages described below:
enabling of the carriage 14 with the sensor 39;
horizontal positioning of the blades 20, 21;
vertical positioning of the blades 20, 21 at the first measured position;
confirmation of the positioning by the numerical control handled by the control unit;
measurement of the horizontal distance at the preselected point;
waiting in position for a predetermined period of time;
control of the stability of the axes; if this is confirmed, the procedure continues, if not the metering process is suspended;
data storage.

If measurement of the points is not complete, then the blades are moved to another vertical position, otherwise the data are processed and the bending angle is calculated.

A description is given below *of the stages involved in the self-calibration of the bending machine 10 for machining panels by, means of a system of feedback control of the bending angle

The sheet 35 is transferred between the counter-punch 24 and the punch 32 which clamp it in position.

The sheet is bent at a lesser angle than the set angle.

The punch 32 is raised and a manipulator moves the edge of the sheet 35 forward, for example by 10 millimetres.

The punch 32 is lowered onto the sheet 35 again, and in the meantime the blades 20, 21 and the sensor are positioned 39.

The measurement is now taken and the data are transmitted to the electronic,control unit which processes them.

If the measurement is not reliable, the process is repeated; otherwise the bending angle is calculated and the correction is defined.

The data acquired are then sent to the numerical control handled by the control unit.

If the bend has been made correctly, the next bending stage is carried out; if not, the punch 32 is raised and the edge of the sheet 35 is withdrawn, for example by 10 millimetres, the punch 32 is lowered again and the bend is completed.

A description is given below of the stages involved in the self-calibration of the centering of the punch 32 by means of a control system that makes it possible to measure the angle obtained at various points of the bend.

The sheet 35 is positioned and clamped in place by the descent of the punch 32. The bending is carried out and the carriage 14 with the sensor 39 are moved in line with the first measurement point corresponding to the length of the sheet 35.

The measurement is taken and transmitted to the electronic control unit which processes it.

If the measurement is reliable, the carriage 14 is moved in order to carry out another measurement.

From the processing of the data relative to the measurements made, it is possible to establish whether the centering of the punch 32 is correct or not.

In the first case, the programme is left unchanged; in the second, the bending programme is modified.

The invention is described above with reference to a preferred embodiment.

It is nevertheless clear that the invention is susceptible to variations which are within the framework of technical equivalents.

By way of example, although the system according to this invention is described and illustrated as applied to a bending machine equipped with a “C” shaped blade-holder structure, it is clear that the invention can be applied to any other type of bending machine, in which the bending blade is also moved in other ways easily imaginable by an expert in the sector.

Moreover, although the system according to this invention is described and illustrated as applied to a bending machine equipped with an ASP carriage on which a sensor is mounted, it is clear that, depending on the technology used, alternative embodiments can easily be implemented foreseeing several fixed or mobile sensors according to design and machining requirements or needs.

1. A system for metering the bending angle of a metal sheet or section in a bending machine which comprises a fixed bed to support the sheet or section to be machined, a support frame for a press comprising at least one mobile punch and a corresponding fixed counter-punch acting as temporary clamping means of the sheet or section during the bending stage, also comprising at least one bending blade which in operation can be moved towards and away from the sheet or section being machined, in order to shape this sheet or section
wherein the system also comprises means for the remote measurement of the instantaneous bending angle (α) of the piece being machined, the measurement means being suitable to take measurements at least two points of the distance of the piece from the measurement means, to process the data relative to the distances measured, to obtain a value corresponding to the instantaneous bending angle (α) and to convert this value to an electric signal that can be subsequently used in order to check the implementation of the bending method.

2. The system according to claim 1, in which the electric signal generated by the remote measurement means is automatically transmitted to control electronics that regulate the movements of the bending blades.

3. The system according to claim 1, in which the value of the instantaneous bending angle (α) of the piece generated by the remote measurement means is used for manual control of the movements of the bending blades.

4. The system according to claim 1, in which the value of the instantaneous bending angle (α) of the piece generated by the remote measurement means is used to carry out spot checks relative to the quality of the products machined.

5. The system according to claim 1, in which the bending machine comprises a “C” shaped blade-holder structure supporting at least one bending blade, the blade-holder structure moving according to two axes at right angles to each other.

6. The system according to claim 5, wherein the blade-holder structure forms a support guide for a carriage which moves according to a third axis at right angles to the plane defined by the two axes.

7. The system according to claim 6, wherein the measurement means are mounted on the carriage.

8. The system according to claim 7, wherein the measurement means consist of at least one linear or scanning type laser sensor, or of at least one infrared, ultrasound or mechanical sensor.

9. The system according to claim 1, wherein the measurement of the bending angle (α) is carried out by positioning the measurement means in two distinct vertical and lateral positions separated by a predetermined distance (Y) with respect to a bent flap of sheet, and metering two horizontal distances (Xₐ, X_{b}) from the sheet being bent, the angle (α) being determined by the formula:
α=arctan (Y/X_{b}−Xₐ)

10. A method for machining sheet metal by means of a bending machine, which includes:
a preparation stage in which a metal sheet or section is placed on a fixed bed to feed a bending machine;
the transfer of the metal sheet or section towards the at least one bending blade;
the positioning of an edge of the sheet and its subsequent clamping adjacent to the at least one bending blade, keeping one flap protruding towards the blades;
the approach of at least one blade towards the metal sheet or section being machined until the protruding flap is compressed to obtain a predetermined shape;
instantaneous measurement of the bending angle (α) of the sheet with respect to the base;
use of the instantaneous bending angle (α) to check and/or manage, manually or automatically, the method for bending the piece.

11. The method according to claim 10, using a system for the instantaneous measurement of the bending angle,
wherein the system for metering the bending angle of a metal sheet or section in a bending machine comprises a fixed bed to support the sheet or section to be machined, a support frame for a press comprising at least one mobile punch and a corresponding fixed counter-punch acting as temporary clamping means of the sheet or section during the bending stage, also comprising at least one bending blade which in operation can be moved towards and away from the sheet or section being machined, in order to shape this sheet or section; and
wherein the system also comprises means for the remote measurement of the instantaneous bending angle (α) of the piece being machined, the measurement means being suitable to take measurements at least two points of the distance of the piece from the measurement means, to process the data relative to the distances measured, to obtain a value corresponding to the instantaneous bending angle (α) and to convert this value to an electric signal that can be subsequently used in order to check the implementation of the bending method.

12. A bending machine for the machining of metal sheets or sections which comprises:
a fixed bed supporting a metal sheet or section to be machined;
a support frame for a press comprising at least one mobile punch and a corresponding fixed punch acting as temporary clamping means for the metal sheet or section during the bending stage;
at least one bending blade which can be moved towards the metal sheet or section being machined;
the machine further comprising means for the instantaneous measurement of the bending angle (α) of the piece being machined, in which the measurement means generate a measurement value that can be transformed into an electric signal representing the bending angle (α) of the piece.

13. The machine according to claim 12, wherein the measurement means are fixed or mobile with respect to the at least one bending blade.

14. The machine according to claim 12, wherein the measurement means consist of at least one linear or scanning type laser sensor, or of at least one infrared, ultrasound or mechanical sensor.

15. The machine according to claim 12, further comprising a “C” shaped blade-holder structure supporting at least one bending blade, the blade-holder structure moving according to two axes at right angles to each other.

16. The machine according to claim 15, wherein the blade-holder structure forms a support guide for a carriage which moves according to a third axis at right angles to the plane defined by the two axes.

17. The machine according to claim 16, wherein the measurement means are mounted on the carriage.

18. The bending machine according to claim 16 wherein the carriage is the ASP type.
